(19) United States
(12) Patent Application Publication
(10) Pub. No.: US 2007/0263906 A1
(43) Pub. Date: Nov. 15, 2007

(54) Personal Identification Method by Subcutaneous Bloodstream Measurement and Personal Identification Device

(76) Inventors: Hitoshi Fujii, Fukuoka (JP); Naoki Konishi, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/596,975

(22) PCT Filed: May 31, 2005
(86) PCT No.: PCT/JP05/09913

§ 371 Date: Apr. 2, 2007

(30) Foreign Application Priority Data
Jun. 18, 2004 (JP) 2004-181221

(51) Int. Cl. G06K 9/00

(52) U.S. Cl. 382/115; 600/310

(57) ABSTRACT

The personal identification method through the measurement of subcutaneous bloodstream comprising: (1) a step of expanding and irradiating a laser beam to a finger pad and focusing light reflected from a blood vessel layer under skin onto an image sensor plane as laser speckles by using an optical system; (2) a step of determining an amount representing the rate of time variation of the amount of received light at each pixel of the laser speckles, for example, a mean rate of time variation or the reciprocal of the variation of the received light amount which is integrated in accordance with an exposure time of the image sensor, and setting the numerical value thus achieved as a two-dimensional map to thereby achieve a bloodstream map of the finger pad; and (3) a step of comparing a fingerprint pattern appearing as the bloodstream map with preregistered personal data for identification.

### TECHNICAL FIELD

The present invention relates to a personal identification method characterized by measuring subcutaneous bloodstream, and a device for using the method. Particularly, the present invention relates to method and device for extracting a pattern corresponding to a fingerprint from a bloodstream map of a finger pad to identify a person.

### BACKGROUND ART

For guaranty principal identification based on a fingerprint, various methods of inputting a pattern as an image into a computer by using a laser or the like and analyzing the pattern image have been developed up to the present data in place of an old-established method based on visual check. Furthermore, many methods have been proposed for a sensor portion for detecting a fingerprint, and there have been practically used an optical method of directly taking a fingerprint pattern into an image sensor by combining the difference in scattering angle between a ridge and a recess with a total reflection condition and a method of extracting a pattern by using a semiconductor sensor for detecting the difference in charge distribution of a contact surface. Furthermore, a method of extracting a venous pattern of a finger tip or a palm by using near-infrared light to perform personal identification has been proposed and the product using the method has been manufactured. However, all the methods described above have not yet been perfect, and the battle against falsification is being continued.

When a laser beam is irradiated to a living body, the intensity distribution of reflected and scattering light forms dynamic laser speckles (random speckled pattern) due to moving scattering particles such as blood cells, etc. It is known that this pattern is detected on a imaging plane by an image sensor, and time variation of the pattern at each pixel is quantified and displayed in the form of a map, whereby a bloodstream distribution of capillary blood vessels in the neighborhood of the surface of the living body can be imaged. The inventors of this application has proposed some techniques and devices of measuring a subcutaneous bloodstream map under the skin or in the eyeground by using the above phenomenon. However, these documents have neither disclosure nor suggestion concerning the concept and method/means of linking the bloodstream map and the fingerprint pattern and applying them to the personal identification.

Patent Document 1: JP-A-5-73666

Patent Document 2: JP-A-8-16752

Patent Document 3: JP-A-2003-331268

Patent Document 4: JP-B-5-28133

Patent Document 5: JP-B-5-28134

Patent Document 6: JP-A-242628

Patent Document 7: JP-A-8-112262

Patent Document 8: JP-A-2003-164431

Patent Document 9: JP-A-2003-180641

### DISCLOSURE OF THE INVENTION

Problem to be Solved by the Invention

The fingerprint pattern is more complicated in shape than the venous pattern, and thus it may implement a personal identification method having higher accuracy. However, there is a risk that personal identification may be violated by counterfeiting the same shape as a finger pad, for example, by copying the fingerprint or the like. In order to solve this problem, it is effective to use some living information in combination with the fingerprint pattern. The present invention has an object to provide highly-accurate personal identification method and device in which a fingerprint pattern is extracted by using the property that when a bloodstream distribution of a finger pad is measured by a bloodstream measuring technique using laser scattering, the subcutaneous bloodstream distribution is spatially modulated with the ridge-and-recess pattern of the fingerprint, or information based on beat of bloodstream is also extracted at the same time.

Means of Solving the Problem

An object of the present invention is achieved by a personal identification method through the measurement of subcutaneous bloodstream that comprises: (1) a step of expanding and irradiating a laser beam to a finger pad and focusing light reflected from a blood vessel layer under skin onto an image sensor as laser speckles by using an optical system; (2) a step of determining an amount representing the speed of time variation of the amount of received light at each pixel point in the laser speckles, for example, an average time variation rate or the reciprocal of the variation of the received light amount which is integrated in accordance with an exposure time of the image sensor, and setting the numerical value thus achieved as a two-dimensional map to thereby achieve a bloodstream map of the finger pad; and (3) a step of comparing a fingerprint pattern appearing as the bloodstream map with pre-registered personal data for identification, and a personal identification device executing the above-described steps.

Another object of the present invention is achieved by a personal identification method through the measurement of subcutaneous bloodstream that comprises: (1) a step of expanding and irradiating a laser beam to a finger pad and focusing light reflected from a blood vessel layer under skin onto an image sensor as laser speckles by using an optical system; (2) a step of determining an amount representing the speed of time variation of the amount of received light at each pixel point in the laser speckles, for example, a mean rate of time variation or the reciprocal of variation of the received light amount which is integrated in accordance with an exposure time of the image sensor, and setting the numerical value concerned as a two-dimensional map to achieve a bloodstream map of the finger pad; (3) a step of comparing/judging a fingerprint pattern appearing as the bloodstream map with personal data registered in advance; and (4) a step of determining a time variation of average bloodstream in the whole area or some area and comparing/judging the time variation with a predetermined reference, and a personal identification device executing the above-described steps.

### EFFECT OF THE INVENTION

A fingerprint sensing technique of the present invention draws a pattern of a finger by using bloodstream information inherent to a living body and utilizes the fact that the pattern concerned varies with time lapse in synchronism with heart beat, and it is very difficult to counterfeit such a model based on the combination of the two-dimensional pattern and the time axis as described above. Furthermore, there is an advantage that after the pattern of the fingerprint is achieved, a conventional fingerprint pattern comparing method/technique can be directly used.

### BRIEF DESCRIPTION OF THE DRAWINGS

FIG. 1 is a diagram showing the cross-section of the skin of a finger pad.

FIG. 2 is a diagram showing an implementing method using a bloodstream map according to the present invention.

### DESCRIPTION OF REFERENCE NUMERALS

1 horny layer

2 blood vessel layer under skin

3 ridge portion of horny layer

4 recess portion of horny layer

5 semiconductor laser

6 irradiation optical system

7 a finger pad

8 laser spot

9 imaging lens

10 image sensor

11 analyzing personal computer

12 display

13 bloodstream map of a finger pad that corresponds to fingerprint

### BEST MODE FOR CARRYING OUT THE INVENTION

Information achieved from bloodstream, out of information concerning a living body, has a feature that it is impossible to identify a person unless a sensor works on the person while the person is alive. According to the present invention, subcutaneous bloodstream which is spatially modulated by the ridge-and-recess pattern of a fingerprint is measured by a bloodstream measurement technique using laser scattering. In order to measure subcutaneous bloodstream, a laser beam is first expanded and irradiated to a finger pad, and light reflected from the blood vessel layer under skin is focused as laser speckles onto an image sensor using an optical system. The laser speckles are continuously scanned by using the image sensor, an amount representing the speed of time variation of the amount of received light at each pixel, for example, an average time variation rate, or the reciprocal of the variation of the received light amount which is integrated in accordance with the exposure time of the image sensor is determined, and then the numerical value thus achieved is set as a two-dimensional map to thereby achieve a bloodstream map of the finger pad. Subsequently, a fingerprint pattern appearing as the bloodstream map is compared with preregistered personal data and identified. In another mode of the present invention, a step of determining the time variation of the average bloodstream in the whole area or some area, and comparing the time variation thus determined with a predetermined reference for identification is added to the above-described process. In this invention, a step of displaying the bloodstream map thus achieved or the fingerprint pattern, or displaying means may be incorporated, as occasion demands.

The present invention will be described in more detail. For example, light emitted from a compact laser light source such as a semiconductor laser or the like is passed through an optical system to be expanded, and then irradiated to a broad area of a finger pad. This irradiation spot is focused on the light receiving face of a CCD camera or the like through a lens. A picture signal achieved from the CCD camera is subjected to A/D conversion and then taken into a personal computer or microcomputer. Furthermore, an amount representing the speed of the time variation of the amount of received light at each pixel, for example, a mean rate of time variation, or the reciprocal of the variation of the received light amount which is integrated in accordance with the exposure time of the image sensor is determined, and it is displayed in the form of a map to achieve bloodstream map data, as occasion demands. A fingerprint pattern stands out in the thus-represented bloodstream map of capillary blood vessels under the skin of the finger pad by the action and principle described later. This data is compared with pre-registered data and personal identification is carried out. In this invention, a method/means of comparing the fingerprint pattern appearing as the bloodstream map with the pre-registered personal data for identification is not limited to a special one, and a well-known method/means may be used.

The bloodstream map achieved in the present invention is original information achieved from a living body, and thus counterfeiting is more difficult by using only a method of claim 1 of the present invention as compared with the conventional method/means of performing personal identification on the basis of only a fingerprint pattern. However, according to the invention of claim 2 of the present invention, a step of determining the time variation of the average bloodstream in the whole area or some area and then comparing the time variation concerned with a predetermined reference and identifying a person is further provided as (4), and thus counterfeiting is more difficult. Furthermore, for example when a waveform is adopted as the time variation of the average bloodstream in some area, a reference of the waveform which is characteristic of a living body is determined in advance, and the comparison with the waveform thus determined and the identification are carried out, whereby it can be judged whether a person being examined is alive or dead. For example, waveform, amplitude, period or the like may be adopted as the reference.

The action/phenomenon of the present invention may be considered as follows. When a laser beam is expanded and irradiated to a finger pad and then light reflected from the blood vessel layer under skin is imaged onto an image sensor plane through a lens, the light beams scattered from the skin structure, blood cells, etc. interfere with one another, so that a random spot pattern (laser speckles) occurs. This spot pattern varies constantly in connection with movement of scattering particles, and the time variation of the spot pattern is proportional to the speed of the particles, that is, the bloodstream speed. By using this property, an amount representing the rate of the time variation of the amount of received light at each pixel, for example, the mean rate of time variation or the reciprocal of the variation of the received light amount which is integrated in accordance with the exposure time of the image sensor is determined, and the numerical value thus achieved is displayed as a two-dimensional map, thereby achieving a bloodstream map. The numerical value is proportional to the average speed of scattering particles located within an optical path along which a laser beam is incident to the skin, scattered by inner blood cells and then emitted from the surface of the skin to the outside of the skin. Accordingly, as the laser beam passes through a poor-bloodstream portion such as a horny layer or the like for a longer time, the variation of the amount of received light is less, and thus the time variation thereof is slower. Furthermore, the moving speed of the blood cells is varied in synchronism with the heart beat, so that the time variation of the amount of received light measured every scan is fast in the systole of the heart and slow in the diastole of the heart.

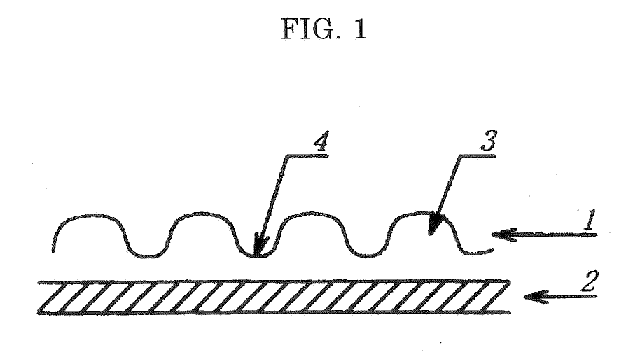

The above-described relationship will be described with reference to the drawings. FIG. 1 is a cross-sectional view showing the skin of a finger pad. Reference numeral 1 represents a horny layer, 2 represents a blood vessel, 3 represents a ridge portion of the horny layer, and 4 represents a recess portion of the horny layer. The fingerprint of the tissue is achieved by connecting minute ridges or recesses on the surface of the horny layer and the connection result is viewed as a pattern. The variation rate of the bloodstream at each ridge portion 3 of the uneven structure is displayed as being low because the horny layer at this portion is thick, and the time variation rate of the bloodstream at each recess portion of the uneven structure is displayed as being high because it reflects the fast bloodstream beneath the recess portion concerned. By using this property, the fingerprint pattern can be achieved, and further the time variation rate of the bloodstream periodically varies in synchronism with the heart beat.

According to the present invention, the time variation component of the scattered laser light is detected and the bloodstream value is analyzed. Therefore, the present invention has an advantage that even when a window portion to which a finger pad is touched is somewhat dirty, the variation component of the scattered light is not greatly affected and a bloodstream map can be achieved.

According to the present invention, there is provided a device for executing the personal identification method comprising the above-described respective steps. The device of the present invention is a personal identification device characterized by comprising: irradiation means for expanding a laser beam and irradiating the expanded laser beam to a finger pad; light receiving means that have many pixels and receives reflection light from the finger pad; storage means for storing the output of each pixel which is achieved by the light receiving means; calculating means for calculating an amount representing the rate of the time variation of the received light amount at each pixel from the storage content of the storage means; second storage means for storing a two-dimensional distribution of the calculation result achieved at each pixel as a fingerprint pattern; and means for comparing the fingerprint pattern stored in the second storage means with preregistered personal data for identification. Furthermore, the device is a personal identification device further equipped with means for determining the time variation of average bloodstream in the whole area or some area and comparing the time variation concerned with a predetermined reference for identification.

For example, as the irradiation means, light emitted from a semiconductor laser is expanded through a lens and irradiated to a broad area of a finger pad at a stroke. As the light receiving means, an image sensor such as a line sensor, an area sensor or the like is used. An electrical signal from the sensor is subjected to A/D conversion, and then stored in a storage portion of a microcomputer or personal computer. An image signal is continuously taken into the storage portion over several seconds, and the difference between two sequential images is determined according to a program set in the microcomputer or the personal computer in advance to calculate the speed of the time variation of the amount of received light. Alternatively, the speed of the time variation of the received light amount is calculated by using the property that when the blurring rate of the image is increased, that is, the light amount varies at high speed within an exposure time of the image sensor, the signal is integrated and thus the difference in two display frames is conversely reduced. The calculation result may be displayed as a two-dimensional color map on the screen of the personal computer according to the arrangement of the respective pixels. As the means of comparing the calculation value or the fingerprint pattern displayed on the display means with pre-registered personal fingerprint patterns for identification, various kinds of well-known means may be used. Furthermore, the time variation of the average bloodstream value in some area of the finger pad over several seconds is determined, and for example, the waveform, amplitude, period or the like of the variation of the bloodstream may be used as a reference for comparison and identification.

### EMBODIMENTS

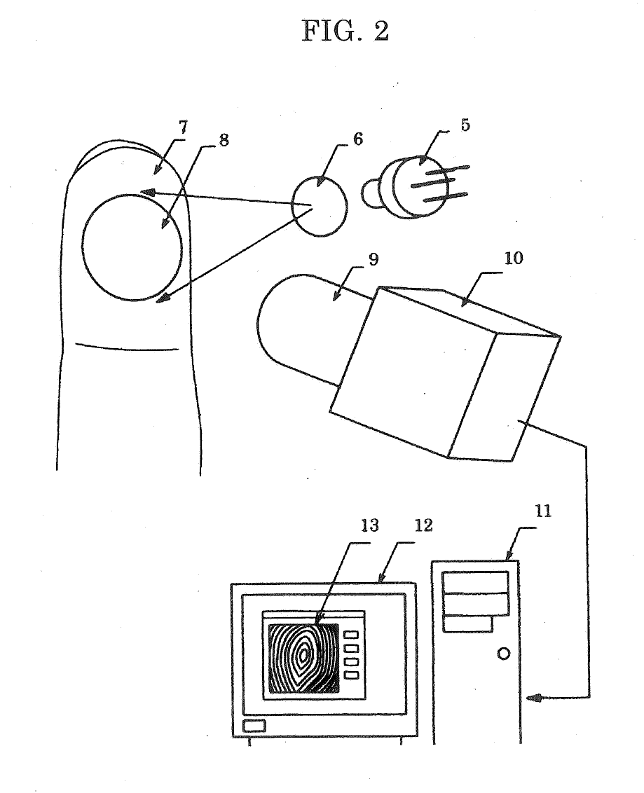

FIG. 2 shows an example of the device of the present invention, and reference numeral 5 represents a semiconductor laser, 6 represents an irradiation optical system, 7 represents a finger pad, 8 represents a laser spot, 9 represents an imaging lens, 10 represents an image sensor, 11 represents an analyzing personal computer, 12 represents a display and 13 represents a bloodstream map corresponding to a fingerprint.

A laser beam scattered from a finger pad forms a random interference fringe pattern (laser speckles) on the image sensor. This pattern varies constantly due to bloodstream, and it varies faster at a thinner portion of the horny layer. Linkage of portions at which the variation of the bloodstream is fast provides the linkage of recess portions of the fingerprint, whereby a fingerprint pattern is achieved. An extraction result of the fingerprint can be observed on the display 12 as indicated by 13 in FIG. 2.

As described above, the fingerprint pattern is extracted from the bloodstream map, and compared with pre-registered personal data by a well-known method/means, whereby a person can be identified with high precision. Furthermore, the time variation rate of the bloodstream within an observation viewing field is varied on the time axis in synchronism with the heart beat, and the amplitude and waveform thereof can be observed on the display. As described above, the fingerprint pattern is extracted from the bloodstream map, and compared with the preregistered personal data, whereby a person can be identified with high precision. In addition, the waveform of the time variation rate of the bloodstream, etc. are extracted, and compared with a predetermined reference, whereby life or death can be judged.

### INDUSTRIAL APPLICABILITY

According to the personal identification method of the present invention, counterfeiting is difficult because a complicated fingerprint pattern and living body information are combined with each other. By making use of this advantage, the personal identification method of the present invention can be applied to an entrance-and-exit check of facilities to which high-level security control is required, immigration control, etc.

1-4. (canceled)

5. A personal identification method through the measurement of subcutaneous bloodstream comprising:
(1) a step of expanding and irradiating a laser beam to a finger pad and focusing light reflected from a blood vessel layer under skin onto an image sensor plane as laser speckles by using an optical system;
(2) a step of determining an amount representing the rate of time variation of the amount of received light at each pixel point in the laser speckles and setting the numerical value thus achieved as a two-dimensional map to thereby achieve a bloodstream map of the finger pad; and
(3) a step of comparing a fingerprint pattern appearing as the bloodstream map with pre-registered personal data for identification.

6. A personal identification method through the measurement of subcutaneous bloodstream comprising:
(1) a step of expanding and irradiating a laser beam to a finger pad and focusing light reflected from a blood vessel layer under skin onto an image sensor plane as laser speckles by using an optical system;
(2) a step of determining an amount representing the rate of time variation of the amount of received light at each pixel point in the laser speckles and setting the numerical value concerned as a two-dimensional map to achieve a bloodstream map of the finger pad;
(3) a step of comparing a fingerprint pattern appearing as the bloodstream map with pre-registered personal data for identification; and
(4) a step of determining a time variation of average bloodstream in the whole area or some area and comparing the time variation with a predetermined reference for identification.

7. A personal identification device comprising: irradiating means for expanding a laser beam and irradiating the expanded laser beam to a finger pad; light receiving means that has many pixels and receives light reflected from a subcutaneous blood vessel layer of the finger pad; storage means for storing the output of each pixel achieved by the light receiving means; calculation means for calculating an amount representing the rate of time variation of the received light amount at each pixel from the storage content of the storage means; second storage means for storing a two-dimensional distribution of the calculation result achieved at each pixel as a fingerprint pattern; and means for comparing the fingerprint pattern stored in the second storage means with pre-registered personal data for identification.

8. A personal identification device comprising: irradiating means for expanding a laser beam and irradiating the expanded laser beam to a finger pad; light receiving means that has many pixels and receives light reflected from a subcutaneous blood vessel layer of the finger pad; storage means for storing the output of each pixel achieved by the light receiving means; calculation means for calculating an amount representing the rate of time variation of the received light amount at each pixel from the storage content of the storage means; second storage means for storing a two-dimensional distribution of the calculation result achieved at each pixel as a fingerprint pattern; means for comparing the fingerprint pattern stored in the second storage means with pre-registered personal data for identification; and means for calculating time variation of average bloodstream in the whole area or some area and comparing the time variation concerned with a predetermined reference for identification.
